(19) United States
(12) Patent Application Publication
(10) Pub. No.: US 2010/0007769 A1
(43) Pub. Date: Jan. 14, 2010

(54) IMAGE CAPTURING DEVICE CAPABLE OF AUTOMATICALLY MAGNIFYING FACE PORTION IN IMAGE AND MAGNIFYING METHOD THEREOF

(75) Inventor: HUNG-YUAN CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,791

(22) Filed: Dec. 30, 2008

(30) Foreign Application Priority Data
Jul. 8, 2008 (CN) 200810302621.X

(51) Int. Cl. H04N 5/76; G06K 9/00

(52) U.S. Cl. 348/231.99; 382/118; 348/E05.031

(57) ABSTRACT

An image capturing device includes a memory, a display unit, and a face-portion magnifying system. The memory stores an image including a matrix of image pixels. The display unit includes a screen. The face-portion magnifying system is configured for: recognizing any human face contained in the image and determining a face portion in the image if human face(s) is recognized, determining whether the number of the image pixels of the determined face portion is greater than the resolution of the screen, magnifying the determined face portion if the number of the image pixels of the determined face portion is greater than the resolution of the screen, and displaying the magnified face portion on the screen.

### BACKGROUND

1. Technical Field

The present disclosure relates to imaging technology and, particularly, to an image capturing device, which can automatically magnify a face portion in an image and a magnifying method thereof.

2. Description of the Related Art

Image capturing devices, such as digital still cameras and camcorders, typically have a facial recognition function to facilitate a user to capture a portrait image. After the portrait image is captured, the user may review the portrait image via a display of the devices to determine whether face portion(s) in the captured image is focused and/or the desired facial expression is captured. To provide more information for determination, the user may need to manually zoom in on a face portion in the captured image. This task is inconvenient. Therefore, what is needed is to provide an image capturing device, which can automatically magnify the face portion and a magnifying method.

### BRIEF DESCRIPTION OF THE DRAWINGS

FIG. 1 is a schematic view of an image capturing device, according to an exemplary embodiment.

FIG. 2 is a functional block diagram of the image capturing device of FIG. 1.

FIG. 3 is a flowchart of a magnifying method for magnifying a face portion in an image, in accordance with the embodiment.

FIG. 4 is a first exemplary schematic view of a screen of the image capturing device of FIG. 1.

FIG. 5 is a second exemplary schematic view of the screen of the image capturing device of FIG. 1.

FIG. 6 is a third exemplary view of the screen of the image capturing device of FIG. 1.

FIG. 7 is a fourth exemplary view of the screen of the image capturing device of FIG. 1.

### DETAILED DESCRIPTION OF THE EMBODIMENTS

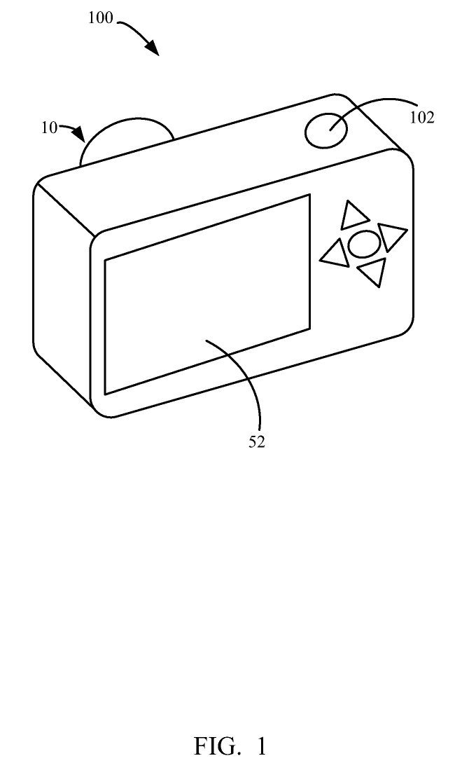

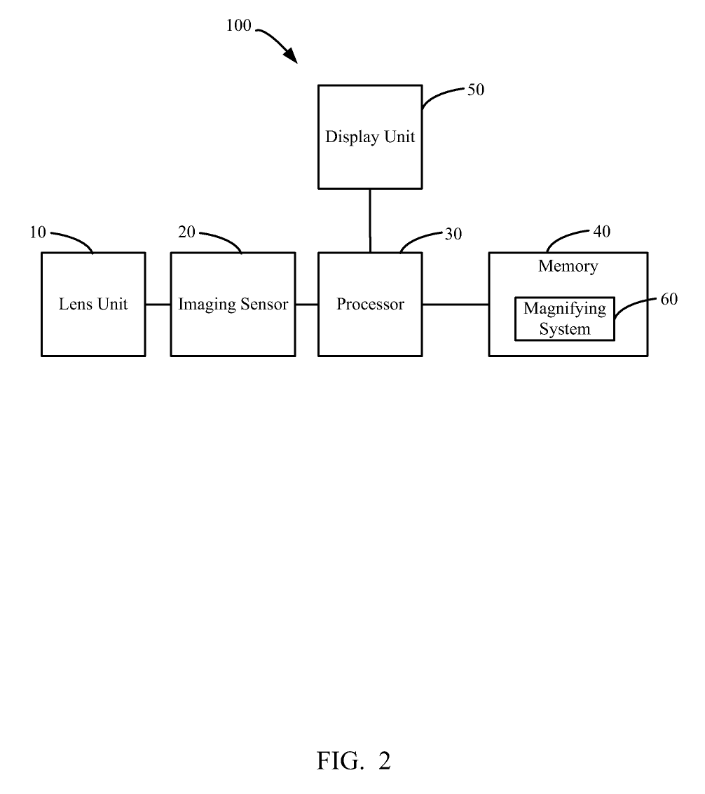

Referring to FIGS. 1-2, an image capturing device 100, such as a digital still camera, according to an exemplary embodiment, includes a lens unit 10, an imaging sensor 20, a processor 30, a memory 40, and a display unit 50. The display unit 50 includes a screen 52.

The lens unit 10 is configured for focusing light to expose the imaging sensor 20. The imaging sensor 20 is configured for capturing an image corresponding to the focused light. The imaging sensor 20 may include a solid imaging element, such as a complementary metal oxide semiconductor (CMOS) or a charge coupled device (CCD). The captured image includes a matrix of image pixels formed by a matrix of optical detectors of the solid imaging element. The processor 30 is configured for controlling the display unit 50 to display the captured image on the screen 52. The memory 40 stores the captured image and software module(s) which, when executed by the processor 30, functions as a face-portion magnifying system 60. The face-portion magnifying system 60 is configured for recognizing any human face contained in the captured image and determining a face portion in the captured image if human face(s) is recognized. The face-portion magnifying system 60 is configured for determining whether the number of image pixels of the determined face portion is greater than the resolution of the screen 52 and, if yes, magnifying the face portion (see below) and displaying the magnified face portion on the screen 52. In other alternative embodiments, the face-portion magnifying system 60 can be a dedicated chip or is integrated into the processor 30.

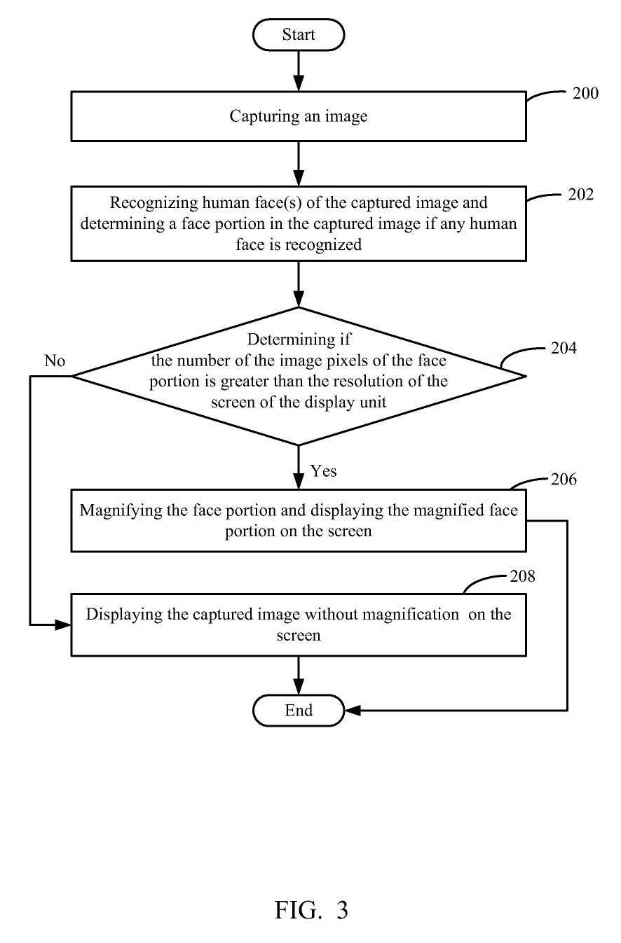

Referring to FIG. 3, a magnifying method of the image capturing device 100 includes steps 200-208. Step 200: capturing an image. Step 202: recognizing human face(s) of the captured image and determining a face portion in the captured image if any human face is recognized. Step 204: determining whether the number of image pixels of the face portion is greater than the resolution of a screen on which the captured image is displayed. If yes, the process goes to step 206, and if no, goes to step 208. Step 206: magnifying the face portion greater and displaying the magnified face portion on the screen. Step 208: displaying the captured image, without magnification, on the screen.

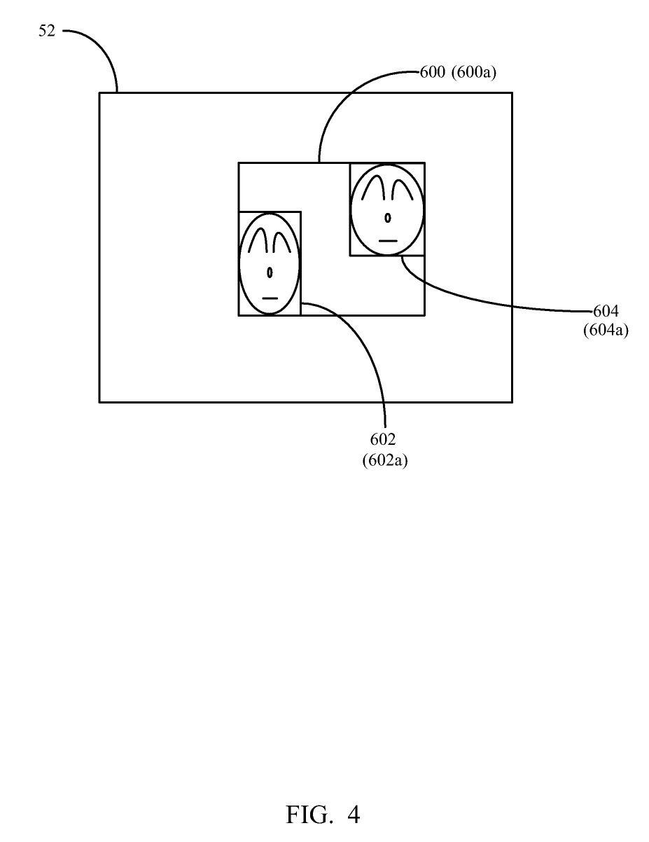

In step 200, a user may wish to take an image of two or more people by depressing a shutter key 102 of the image capturing device 100. In this case, the captured image includes the two or more human faces. In step 202, the face recognition function is performed by any available face recognition algorithm. In this embodiment, the face recognition is implemented by the face-portion magnifying system 60, and the recognized face portion is rectangular. Referring to FIG. 4, when the processor 30 activates the face-portion magnifying system 60, a face portion 600 is determined. In detail, the face-portion magnifying system 60 may firstly detect two rectangular sub-portions 602, 604, which are framed by two rectangular frames 602a, 604a. The face portion 600 is defined by a big rectangular frame 600a framing the two sub-portions 602, 604.

In step 204, the resolution of the screen 52 of the display unit 50 is m×n pixels. In this embodiment, m=640 and n=480. The face-portion magnifying system 60 determines whether the number of image pixels M×N of the face portion 600 is more than 640×480, where m and M are number of pixels on horizontal dimensional grid, and n and N are number of pixels on vertical dimensional grid.

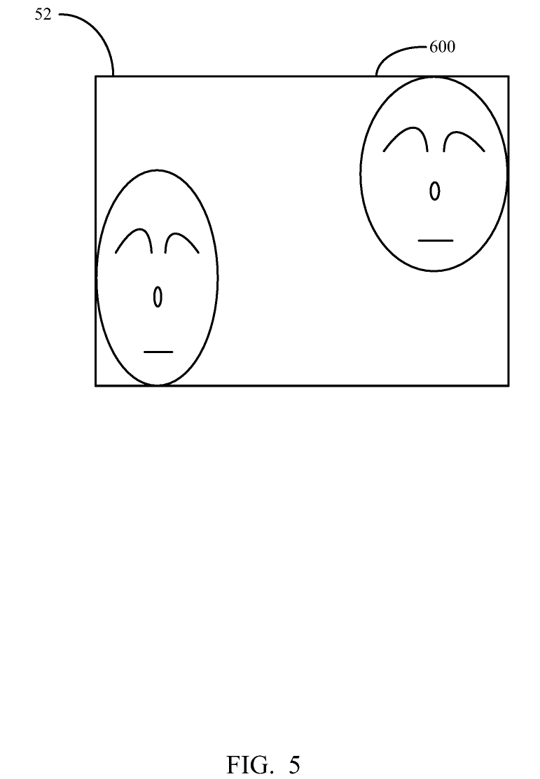

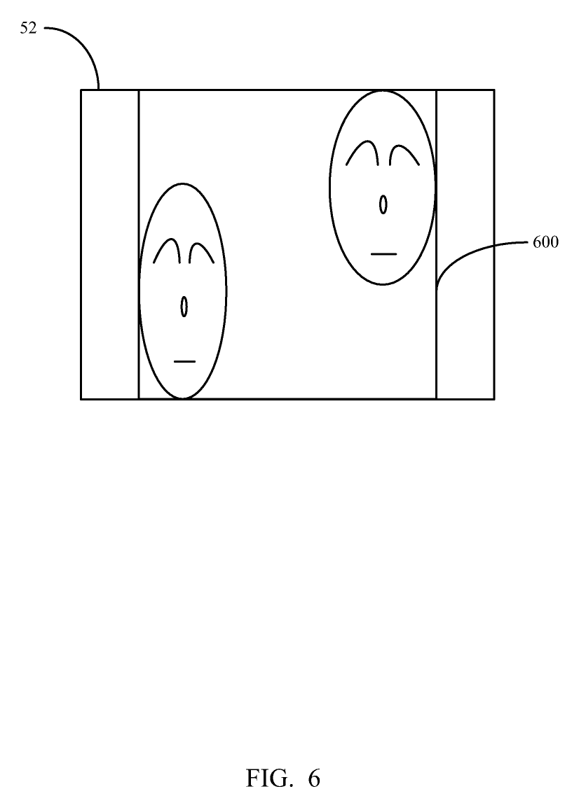

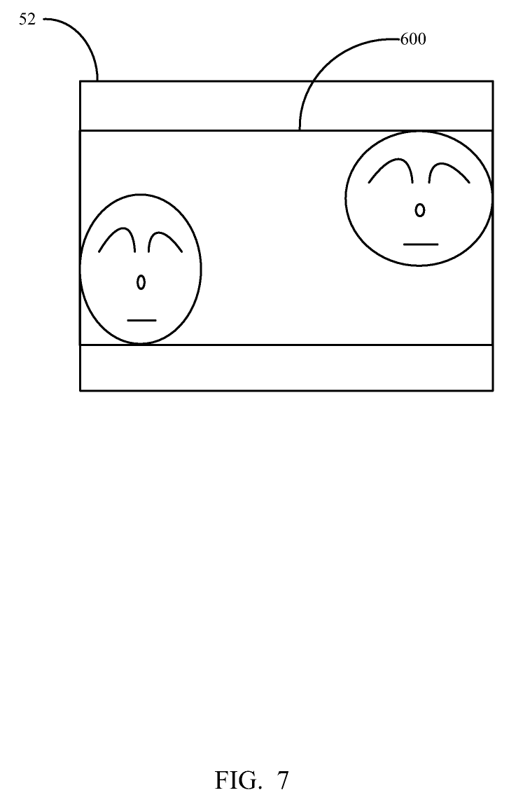

In step 206, if N≧n and M≧m, i.e., N≧480 and M≧640, the face-portion magnifying system 60 magnifies the face portion 600 up to full-screen, as shown in FIG. 5. If N≧n and M<m, i.e., N≧480 and M<640, the face-portion magnifying system 60 magnifies the face portion 600 vertically up to fitting the height of the screen 52, as shown in FIG. 6. if N<n and M≧m, i.e., N<480 and M≧640, the face-portion magnifying system 60 magnifies the face portion 600 horizontally up to fitting the width of the screen 52, as shown in FIG. 7.

In step 208, if the number of image pixels contained in the face portion 600 is equal to or less than the resolution of the screen 52 of the display unit 50, the processor 30 controls the display unit 50 to display the captured image without magnification on the screen 52.

In summary, after the image is captured, a face portion in the captured image can be magnified to display on the screen. Therefore, it is convenient for a user to decide whether the faces in the captured image are gotten into focus or the desired face expression is captured.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An image capturing device comprising:
a memory for storing an image, the image comprising a matrix of image pixels;
a display unit comprising a screen; and
a face-portion magnifying system configured for:
recognizing any human face contained in the image and determining a face portion in the image if human face(s) is recognized;
determining whether the number of the image pixels of the determined face portion is greater than the resolution of the screen;
magnifying the determined face portion if the number of the image pixels of the determined face portion is greater than the resolution of the screen; and
displaying the magnified face portion on the screen.

2. The image capturing device as claimed in claim 1, further comprising a processor configured for executed the face-portion magnifying system.

3. The image capturing device as claimed in claim 2, further comprising a lens unit, and an imaging sensor, the lens unit being configured for focusing light to expose the imaging sensor, the image sensor configured for capturing the image corresponding to the focused light.

4. The image capturing device as claimed in claim 3, wherein the imaging sensor comprises a complementary metal oxide semiconductor.

5. The image capturing device as claimed in claim 3, wherein the imaging sensor comprises a charge coupled device.

6. A magnifying method for magnifying a face portion in an image to display on a screen, the image comprising a matrix of image pixels, the method comprising:
recognizing any human face contained in the image and determining a face portion in the image if human face(s) is recognized;
determining whether the number of the image pixels of the determined face portion is greater than the resolution of the screen;
magnifying the determined face portion if the number of the image pixels of the determined face portion is greater than the resolution of the screen; and
displaying the magnified face portion on the screen.

7. The method as claimed in claim 6, wherein the face portion is rectangular shaped.

8. The method as claimed in claim 7, wherein the resolution of the screen is m×n pixels, and the number of image pixels of the face portion is M×N, where m and M are number of pixels on horizontal dimensional grid, and n and N are number of pixels on vertical dimensional grid.

9. The method as claimed in claim 8, wherein if N≧n and M≧m, magnifying the face portion up to full-screen.

10. The method as claimed in claim 8, wherein if N≧n and M<m, magnifying the face portion vertically up to fitting the height of the screen.

11. The method as claimed in claim 8, wherein if N<n and M≧m, magnifying the face portion horizontally up to fitting the width of the screen.

12. The method as claimed in claim 6, further comprising: displaying the captured image without magnification on the screen if the number of the image pixels contained in the face portion is equal to or less than the resolution of the screen.
